(19) United States
(12) Patent Application Publication
(10) Pub. No.: US 2012/0269689 A1
(43) Pub. Date: Oct. 25, 2012

(54) DEVICE FOR CONTROLLED PRODUCTION OF HYDROGEN

(75) Inventors: Alfonso Pozio, Roma (IT); Massimo De Francesco, Bracciano (IT); Stefano Galli, Anguillara (IT); Rosanna Oronzio, Civitavecchia (IT)

(73) Assignees: Genport S.r.l, Lomagna (IT); Agenzia Nazionale Per Le Nuove Tecnologie L'Engergia E Lo Suiluppo Economico Sostenibile, Roma (IT)

(21) Appl. No.: 13/516,096

(22) PCT Filed: Dec. 20, 2010
(86) PCT No.: PCT/IB10/55947

§ 371 Date: Jul. 11, 2012

(30) Foreign Application Priority Data
Dec. 18, 2009 (IT) RM2009U000199

(51) Int. Cl. B01J 19/00

(52) U.S. Cl. 422/162

(57) ABSTRACT

A device for producing hydrogen from borohydride, comprising a first tank (6) capable of housing water, a second tank (7) in which there is housed a mixture consisting of a solid borohydride and a solid organic acid under normal conditions, and connection means (5, 9) capable of allowing the water to pass from the first tank (6) to the second tank (7).

The present invention relates to a device for the controlled production of hydrogen.

For some time now, hydrogen (H₂) has been the subject of numerous studies for optimising the exploitation thereof in energy production processes. Hydrogen is rightly considered to be a means of storing energy and not a source of energy. In this regard, hydrogen may be an interesting support for processes for producing energy from renewable sources, such as for example solar energy, photovoltaic energy and hydroelectric energy, the efficacy of which is associated with particular environmental conditions. In fact, it is possible for the excess energy produced by renewable sources under optimal environmental conditions to be transformed into hydrogen, which will subsequently be used to produce energy when the environmental conditions no longer allow the use of said renewable sources.

Moreover, the hydrogen produced can also be used to produce certain chemical and industrial products which are currently obtained by using fossil fuels, these being exhaustible and highly polluting sources.

One of the most promising systems for using hydrogen is represented by fuel cells which, through the supply of hydrogen, are able to produce electrical energy directly with a high efficiency of conversion.

The main obstacles to the widespread use of hydrogen are due mainly to the accumulation and transport thereof.

The methods presently used for storing hydrogen substantially involve the transformation thereof into compressed gas or liquid gas, or the incorporation thereof in metal hydrides or in carbon nanotubes.

However, the methods mentioned above suffer from problems relating to a high cost of management and/or to a technology that is still young and therefore not yet perfected.

One method of storing hydrogen which on the contrary seems to be more promising involves the use of chemical hydrides, in particular alkali metal borohydrides.

In this case, the hydrogen is imprisoned in the chemical bonds of the boron and of the alkali metal forming a salt which is able to release hydrogen once it is reacted with water. The exothermic reaction for producing hydrogen from sodium borohydride is shown below.

NaBH₄+2H₂O→NaBO₂+4H₂

Sodium borohydride is a thermally stable and hygroscopic white crystalline salt which decomposes by hydrolysis according to the reaction shown above.

The rate of decomposition of aqueous borohydride solutions is shown by the following equation (Mochalo et al., Kinet. Katal. 6, 1965, 541) expressed in terms of its half-life (time taken for the hydrolysis of 50% by weight of the initial borohydride).

log t½=pH−(0.034 T−1.92)

where t½ is expressed in minutes and T is the temperature expressed in degrees Kelvin. As can be seen from the above equation, the rate of decomposition can be controlled by varying the acidity (pH) and/or the temperature T. It has in fact been verified experimentally that the kinetics of the reaction of sodium borohydride slow down within a short period of time due to the increase in the pH brought about by the formation of the basic metaborate salt.

Therefore, in order for an aqueous borohydride solution not to give off hydrogen and to be stable at room temperature, it is necessary to maintain the pH at values close to 14 by adding sodium or potassium hydroxide.

Various solutions have been found for using the hydrolysis of borohydride to produce hydrogen in a controlled manner, and some of these involve the use of metal catalysts. In this regard, mention will be made of the patents U.S. Pat No. 5,804,329 and U.S. Pat. No. 6,358,488 and of the scientific article “Kojima et al., Int. Journal of Hydrogen Energy, 27, 2002, 10”. Although these solutions succeed in ensuring high kinetics of the borohydride decomposition reaction, they nevertheless suffer from the disadvantage that the borohydride solution must necessarily be used with an alkali metal hydroxide dissolved therein as stabiliser. The limit of this process is therefore the use of a corrosive aqueous solution, the reduced energy density (10% by weight) and a complex preparation. These solutions have the further problem that it is necessary to use complex and expensive catalytic systems based on noble metals which moreover tend to deactivate over time.

Other solutions, as described in the patent application RM2006A000221, involve firstly mixing, in the solid state, the metal catalysts with the borohydride and then carrying out a decomposition reaction by adding water in the vapour state to the solid mixture. Although said patent solves the problems arising from the use of basic solutions and the relative instability thereof as well as the obstacle that the solid catalyst must be intimately mixed with the borohydride, it has the disadvantage of a reduced yield. Moreover, the use of vapour brings further problems due to the evaporation of the water and the resulting energy expenditure.

Finally, as described in the patent application RM2005A000132, a solution has been implemented in which the direct reaction between a basic aqueous solution of borohydride and an acidic aqueous solution is carried out. In particular, there is described a portable device for the production of hydrogen based on the controlled mixing of a hydrochloric acid solution in a reactor containing solid NaBH₄. As may be obvious to a person skilled in the art, such a system suffers from problems linked to managing the storage and flow of the acid solution, with the associated safety problems linked to the use of corrosive substances.

The aim of the present invention is to provide a device for the controlled production of hydrogen from borohydride, which operates by a method having technical characteristics which are such as to avoid the disadvantages of the prior art and at the same time operates without any or with a minimum external energy supply, and the dimensions of which can be of reduced weight and size.

The present invention relates to a device for the controlled production of hydrogen, the essential features of which are given in claim 1 and the preferred and/or auxiliary features of which are given in claims 2-7.

For a better understanding of the invention, one embodiment will be discussed below purely by way of non-limiting example and with the aid of the figures of the appended drawing, in which:

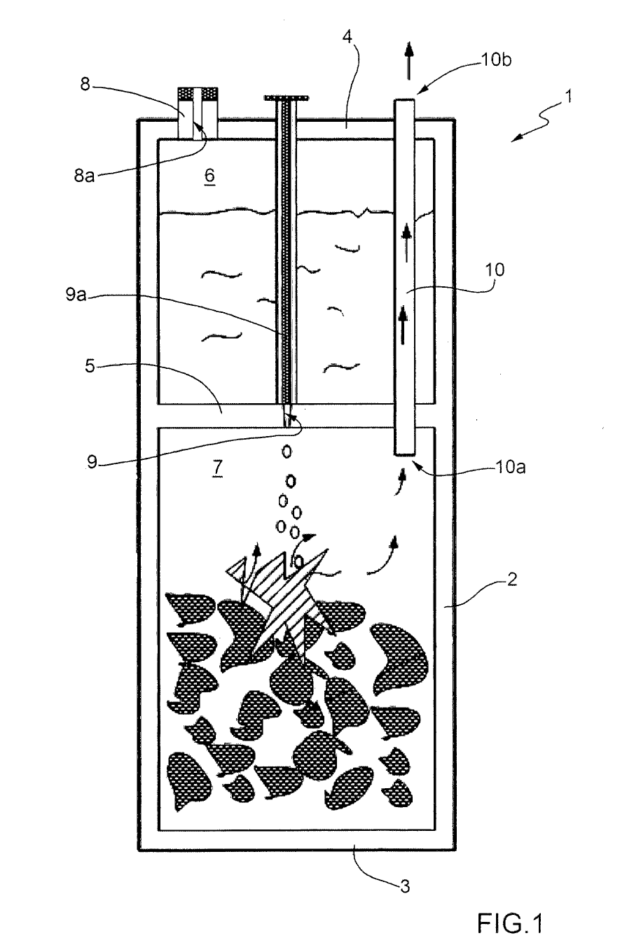

FIG. 1 is a cross-section through one of the possible embodiments of the device which forms the subject of the present invention;

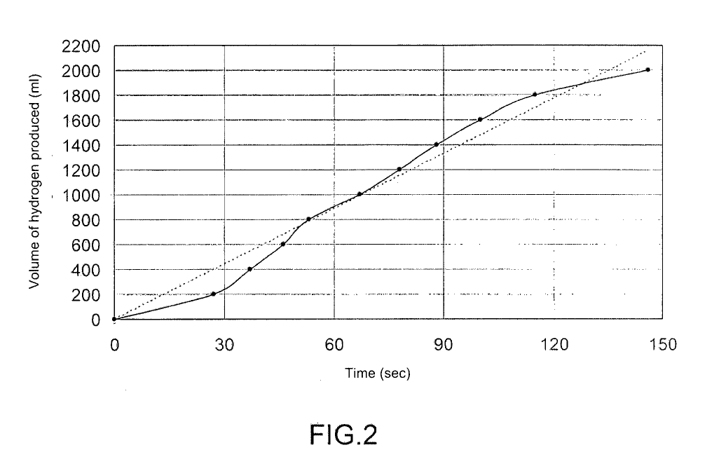

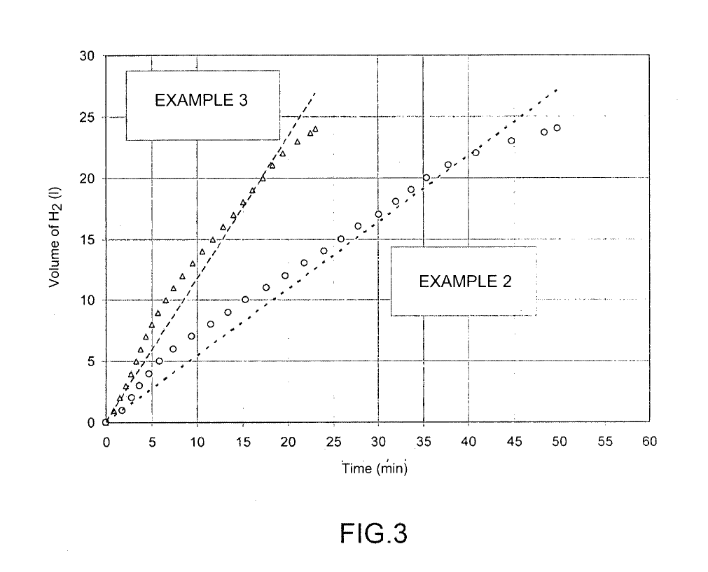

FIGS. 2 and 3 are two graphs relating to the production of hydrogen as a function of time using the device which forms the subject of the present invention.

In FIG. 1, one embodiment of the device which forms the subject of the present invention is designated as 1 in its entirety. The device 1 has a cylindrical shape and may be made using various materials, for example in this case use has been made of a plastic material and aluminium. In particular, the device 1 has a height of 22 cm, a diameter of 8 cm and an empty weight of 400 g.

The device 1 comprises a cylindrical side wall 2 which is closed at the bottom by a bottom wall 3 and at the top by a top wall 4. The device 1 furthermore comprises a dividing wall 5 arranged inside the side wall 2 between the bottom wall 3 and the top wall 4. In this way, there is defined in the device 1 an upper tank 6, which during use is capable of housing water, and a lower tank 7 in which there is housed a mixture consisting of solid borohydride and solid organic acid. Water is poured into the upper tank 6 through a filling nozzle 8 arranged in the top wall 4 and equipped on the upper part with a vent hole 8a which keeps the upper tank at atmospheric pressure at all times. The water poured into the upper tank 6 needs not necessarily be of a particular degree of purity.

The organic acid under consideration in the present invention must have a minimum length of its hydrocarbon chain of C₂, must be solid under normal conditions so as to be able to be mixed with the solid borohydride, and must be very soluble in water. Preferably, the organic acid under consideration in the present invention is selected from the group consisting of tartaric acid, oxalic acid, citric acid, ascorbic acid and other organic acids having a high number of carboxyl (COOH) functional groups.

The upper tank 6 communicates with the lower tank 7 via an opening 9, through which there flows a flow of aqueous liquid, the rate of which can be regulated via a valve 9a (for example a needle valve), which may be manual or automatic.

Finally, the device 1 comprises a conduit 10, through which the hydrogen produced by the hydrolysis reaction escapes from the device 1. The conduit 10 is arranged so as to pass through both the dividing wall 5 and the top wall 4, so that its inlet end 10a is arranged so as to dip into the lower tank 7 and its outlet end 10b is arranged beyond the top wall 4. The conduit 10 may also be arranged horizontally in such a way as to pass directly through the side wall 2.

The water enters the lower tank 7 through the flow regulating valve 9 in order to react with the borohydride/acid mixture housed therein. The hydrogen formed by the reaction escapes from the device 1 through the conduit 10 so as to be able to be subsequently used for example in an energy production device, such as a fuel cell for example.

As will be seen below, the device which forms the subject of the present invention makes it possible to regulate the flow of hydrogen produced as a function of the flow of water admitted through the flow regulating valve 9.

The device preferably comprises a passive safety system which automatically prevents any inflow of water in the event of overpressure in the lower tank 7. Such a safety system could consist of a non-return valve placed close to the opening 9.

The organic acid dissolving in the water reduces the pH value and promotes the kinetics of the borohydride hydrolysis reaction, thereby avoiding any slowing-down of the hydrogen production reaction and solving the major problem encountered in the prior art.

The residue of the reaction will be a non-polluting concentrated and dense solution of metaborate mixed with the corresponding salt of the organic acid (citrate, oxalate, etc.). If the organic acid is added in a suitable quantity, it is moreover possible to obtain a final residue with a neutral pH, so that the residue itself can be disposed of without any additional processing or treatment.

### EXAMPLES OF PRODUCTION OF H₂

### Example 1

A quantity of solid sodium borohydride equal to 0.8 g and a quantity of solid citric acid equal to 1.4 g were intimately mixed together and placed in the lower tank 7. Placed in the upper tank 6 were 3.2 ml of water taken directly from the normal water supply system. The needle valve 9 was regulated to ensure a flow of water equal to 1.6 ml/min.

The graph in FIG. 2 shows the volume of hydrogen produced as a function of time under the conditions given above. In 120 sec, approximately two litres of hydrogen are produced, equal to around 15 cc of hydrogen per second. The pH of the borate/organic acid solution after the test was 7.5.

From what has been seen above, it can be calculated that a device comprising an upper tank 6 having a capacity of around 140 cc of water can produce approximately 87.5 litres of hydrogen. For such a production of hydrogen, it would be necessary to fill the lower tank 7 with 34 grams of NaBH₄ and 60 grams of organic acid. Considering also the total weight of the device (400 g) and the estimated weight of the reagents (234 g), an energy density of the device as a whole of 379 Wh/kg is obtained (126 litres under normal conditions per kg).

The hydrogen output rate is determined exclusively by the needle valve 9 and it is therefore necessary to use a valve with the finest possible regulation so as to obtain the gas flows necessary for the selected application. In order to interrupt the gas output, it is sufficient to interrupt the water delivery.

### Examples 2 and 3

Two other examples of the production of hydrogen were carried out, for which use was made of the same quantity of water and the same quantity of solid mixture but a different flow of water. In particular, in each example, the device was loaded with 28 g of reagents and 100 cc of water. The theoretical quantity of hydrogen that could be produced was 23.74 litres (c.n.) and in the end a yield of 100% was obtained experimentally.

Table I shows the overall features of the two examples.

TABLE I

Example

| | 2 | 3 |
|---|---|---|
| NaBH4 (g) | 10 | 10 |
| Citric acid (g) | 18 | 18 |
| Loaded volume of H₂O (cc) | 100 | 100 |
| Theoretical volume of H₂O (cc) | 40 | 40 |
| Residual volume of H₂O (cc) | 45 | 60 |
| Initial temperature (° C.) | Ambient | Ambient |
| Flow of H₂O (ml/min) | 1.4 | 1.9 |
| Volume of H₂ produced (l) | 24 | 24 |
| Flow of H₂ produced (l/min) | 0.54 | 1.16 |
| Final pH | 5.5 | 5.3 |

FIG. 3 shows in a graph the two curves relating to the hydrogen produced as a function of time in the respective examples 2 and 3.

In example 2, the quantity of water used was around 55 cc, or approximately 25% more than the theoretical quantity, while in example 3 the water consumption was exactly equal to the theory (40 cc). In both examples, the solid mixture consisting of NaBH₄ and citric acid had a height of 1.5 cm, or a volume of around 75.4 cc. The temperature during example 2 increased to 62-70° C., while in example 3 it increased to 74° C.

In both examples, the residue had a volume of 35-38 cc and was in the form of a liquid-solid mixture with a density similar to that of honey.

Based on the examples given above, it was found to be possible to supply a 100 Watt system using the device which forms the subject of the present invention. A 100 Watt fuel cell composed of 16 cells each having an area of 160 cm² and with an output voltage of 12 V DC would be able to deliver a current of 8.3 A. In order to produce such a current, a theoretical hydrogen flow of 0.93 l/min (56 l/h in c.n.) would be necessary. Therefore, with autonomy of the device for 2 hours, a quantity of hydrogen of 112 litres would be necessary. Table II shows the specifics required by the device which forms the subject of the present invention in order to achieve the desired conditions as a function of the values obtained in examples 2 and 3.

TABLE II

| | target | Example 2 | Example 3 |
|---|---|---|---|
| Autonomy (h) | 2 | 0.83 | 0.38 |
| Volume of hydrogen (l) | 112 | 24 | 24 |
| Flow of hydrogen (l/h) | 56 | 32.4 | 63.2 |
| Weight of NaBH₄ (g) | 47.2 | 10 | 10 |
| Weight of organic acid (g) | 84.9 | 18 | 18 |
| Weight of H₂O (g) | 188.7 | 55 | 40 |
| Total weight of reagents (g) | 328.8 | 83 | 68 |
| Weight of device (g) | 1679 | 400 | 400 |
| Overall weight (g) | 2000 | 483 | 468 |
| Approximate volume (l) | 1.5 | 0.5 | 0.5 |
| Energy density (Wh/kg) | 168 | 150 | 153 |

As can be seen from Table II, considering a total weight of the borohydride production system of around 2 kg, it is necessary to create a device/reactor having a weight of at most 1679 g and a volume of approx. 1.5 litres for a 100 Watt system.

The results obtained in the examples show the possibility of coming within the weight/volume specifics put forward as a hypothesis for a supply target for 100 Watt. In particular, the characteristics of example 3 show the obtaining of a flow of hydrogen greater than required under the supply conditions for the 100 Watt cell (target).

With regard to the autonomy, it is clear that four devices in parallel with the conditions of example 3 (400 g×4=1600 g) and each loaded with 89 g of reagents (12 g of NaBH4+21 g of organic acid+47 g of H₂O) would be able to obtain approximately 112 litres in two hours without any particular problems and with an overall weight less than 2 kg (1600 g+320 g) and a total volume of almost 2 litres.

Besides the needle valve discussed in the description, use may also be made of micropumps which are able to control liquid flows of 1-5 ml/min with a consumption of 0.25 Watt and with a weight of around 2 g, or micropumps which make it possible to meter up to 50 nl/min of liquid. In this way, it would be possible to go down to extremely low flows of hydrogen produced (10 ml/min or less).

The control of the micropump could moreover be slaved to a system for controlling the entire energy generator, hydrogen generator and fuel cell, so as to optimise the performance and hydrogen output.

As is clear from what has been described above, with the device which forms the subject of the present invention it is possible to produce hydrogen in a controlled manner from solid borohydride while at the same time increasing the conversion of the loaded sodium borohydride, the energy density and keeping costs lows, without suffering from the disadvantages of the known prior art described above.

Moreover, the device which forms the subject of the present invention offers the considerable advantages of being able to be formed with a weight and a geometry such as to make it easily portable and integrated, able to operate with water coming from the normal water supply system or even of low purity and involving the use of organic acids of particularly low cost.

Finally, the device of the present invention, in the case of both manual management and automatic management with the presence of a micropump, makes it possible to interrupt and restart the production of hydrogen at will by respectively interrupting and reactivating the water flow.

With regard to the use of the device which forms the subject of the present invention, the ideal collocation thereof would have to be the production of hydrogen for small, commercially available fuel cell stacks having a power of 10-100 Watt which can be used to supply portable electronic devices such as computers, PDAs, mobile phones, transmitters, etc. For such an application, 100-1000 cc/min of hydrogen are required. By suitably calibrating the outgoing flow of hydrogen, it is possible to ensure an autonomy varying between 3-12 h.

1. Device for producing hydrogen from borohydride, said device being wherein it comprises a first tank capable of housing water, a second tank in which there is housed a mixture comprising a solid borohydride and a solid organic acid under normal conditions, and connection means capable of allowing the water to pass from said first tank to said second tank.

2. Device according to claim 1, wherein said communication means comprise a flow regulating valve or a micropump.

3. Device according to claim 1, wherein it comprises a conduit for the escape of the hydrogen produced, said conduit being arranged so that one end dips into said second tank.

4. Device according to claim 1, wherein it comprises a side wall which is closed at the bottom by a bottom wall and at the top by a top wall, and a dividing wall arranged inside the side wall between the bottom wall and the top wall, there being formed in said top wall a water filling nozzle equipped with a vent hole on the upper part.

5. Device according to claim 1, wherein said organic acid has a minimum length of C2, is solid under normal conditions and is soluble in water.

6. Device according to claim 5, wherein said organic acid is selected from the group consisting of tartaric acid, oxalic acid, citric acid, ascorbic acid and mixtures thereof.

7. Device according to claim 1, wherein it comprises a passive safety system capable of automatically interrupting the delivery of water from said first tank to said second tank in the event of overpressure of the latter.

8. Device according to claim 2, wherein it comprises a conduit for the escape of the hydrogen produced, said conduit being arranged so that one end dips into said second tank.

9. Device according to claim 2, wherein it comprises a side wall which is closed at the bottom by a bottom wall and at the top by a top wall, and a dividing wall arranged inside the side wall between the bottom wall and the top wall, there being formed in said top wall a water filling nozzle equipped with a vent hole on the upper part.

10. Device according to claim 3, wherein it comprises a side wall which is closed at the bottom by a bottom wall and at the top by a top wall, and a dividing wall arranged inside the side wall between the bottom wall and the top wall, there being formed in said top wall a water filling nozzle equipped with a vent hole on the upper part.

11. Device according to claim 2, wherein said organic acid has a minimum length of C2, is solid under normal conditions and is soluble in water.

12. Device according to claim 3, wherein said organic acid has a minimum length of C2, is solid under normal conditions and is soluble in water.

13. Device according to claim 4, wherein said organic acid has a minimum length of C2, is solid under normal conditions and is soluble in water.

14. Device according to claim 2, wherein it comprises a passive safety system capable of automatically interrupting the delivery of water from said first tank to said second tank in the event of overpressure of the latter.

15. Device according to claim 3, wherein it comprises a passive safety system capable of automatically interrupting the delivery of water from said first tank to said second tank in the event of overpressure of the latter.

16. Device according to claim 4, wherein it comprises a passive safety system capable of automatically interrupting the delivery of water from said first tank to said second tank in the event of overpressure of the latter.

17. Device according to claim 5, wherein it comprises a passive safety system capable of automatically interrupting the delivery of water from said first tank to said second tank in the event of overpressure of the latter.

18. Device according to claim 6, wherein it comprises a passive safety system capable of automatically interrupting the delivery of water from said first tank to said second tank in the event of overpressure of the latter.

19. Device according to claim 8, wherein it comprises a side wall which is closed at the bottom by a bottom wall and at the top by a top wall, and a dividing wall arranged inside the side wall between the bottom wall and the top wall, there being formed in said top wall a water filling nozzle equipped with a vent hole on the upper part.

20. Device according to claim 8, wherein said organic acid has a minimum length of C2, is solid under normal conditions and is soluble in water.
